(19) United States
(12) Patent Application Publication
(10) Pub. No.: US 2022/0260679 A1
(43) Pub. Date: Aug. 18, 2022

(54) LIDAR SYSTEM THAT DETECTS MODULATED LIGHT

(71) Applicant: Continental Automotive Systems, Inc., Auburn Hills, MI (US)

(72) Inventors: Paul Vranjes, Santa Barbara, CA (US); Luis Villalobos, Camarillo, CA (US)

(73) Assignee: Continental Automotive Systems, Inc., Auburn Hills, MI (US)

(21) Appl. No.: 17/249,017

(22) Filed: Feb. 17, 2021

(51) Int. Cl. G01S 7/48; G01S 17/894; G01S 17/931; G01S 7/4861; G01S 7/481; B60K 35/00; H04B 10/67; H04B 10/516; G06F 8/65

(52) U.S. Cl. CPC G01S 7/4804; G01S 17/894; G01S 17/931; G01S 7/4861; G01S 7/4813; B60K 2370/179; H04B 10/676; H04B 10/516; G06F 8/65; B60K 2370/1529; B60K 35/00

(57) ABSTRACT

A system includes a lidar system having a light emitter and a light detector and a computer having a processor and a memory storing instructions executable by the processor to demodulate modulated light received by the light detector to extract data from the modulated light. The lidar system receives data both by illuminating a field of view (FOV) of the lidar system and detecting returned light reflected by objects in the field of view FOV and by demodulating the modulated light that is received by the lidar system. The lidar system may combine data from both of these sources.

### BACKGROUND

A lidar system includes a photodetector, or an array of photodetectors. Light is emitted into a field of view of the photodetector. The photodetector detects light that is reflected by an object in the field of view. For example, a flash lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The lidar system may be mounted on a vehicle to detect objects in the environment surrounding the vehicle and to detect distances of those objects for environmental mapping. The output of the lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Some applications, e.g., in a vehicle, include several lidar systems. For example, the multiple system may be aimed in different directions and/or may detect light at different distance ranges, e.g., a short range and a long range.

### BRIEF DESCRIPTION OF THE DRAWINGS

FIG. 1 is FIG. 1 is a perspective view of a vehicle having a lidar system.

FIG. 2 is a perspective view of the lidar system.

FIG. 3 is a cross section of the lidar system.

FIG. 4 is a perspective view of components of a light-receiving system of the lidar system.

FIG. 4A is an enlarged illustration of a portion of FIG. 4.

FIG. 5 is a plan view showing several vehicles traveling in a common direction and each including a rearward-facing lidar system, a forward-facing lidar system, and a forward-facing camera.

FIG. 6 shows three vehicles traveling in a common direction with the forward-facing lidar system of vehicle A detecting vehicles B and C.

FIG. 7 shows the three vehicles of FIG. 6 with the forward-facing camera of vehicle B detecting vehicle C, and with the forward-facing lidar system of vehicle A detecting vehicle B and receiving modulated light from the rearwardly-facing lidar system of Figure B.

FIG. 8 shows several vehicles traveling in a common direction with rearward-facing lidar systems of vehicles B and C both transmitting modulated light to the forward-facing lidar system of vehicle A.

FIG. 9 is a view of a heads-up display in a passenger compartment of a vehicle that includes a lidar system that has received modulated light from a transmitting vehicle to see through the transmitting vehicle on the heads-up display.

FIG. 10 is a block diagram of a system of the vehicle including the lidar system.

FIG. 11 is a method of transmitting modulated light by the lidar system.

FIG. 12 is a method including receiving modulated light by the lidar system.

### DETAILED DESCRIPTION

With reference to the Figures, wherein like numerals indicate like parts throughout the several views, a system 10 includes a lidar system 20 including a light emitter 22 and a light detector 18. The system 10 includes a computer 26 having a processor and a memory storing instructions executable by the processor to demodulate light received by the light detector 18 to extract data from the light detected by the light detector 18.

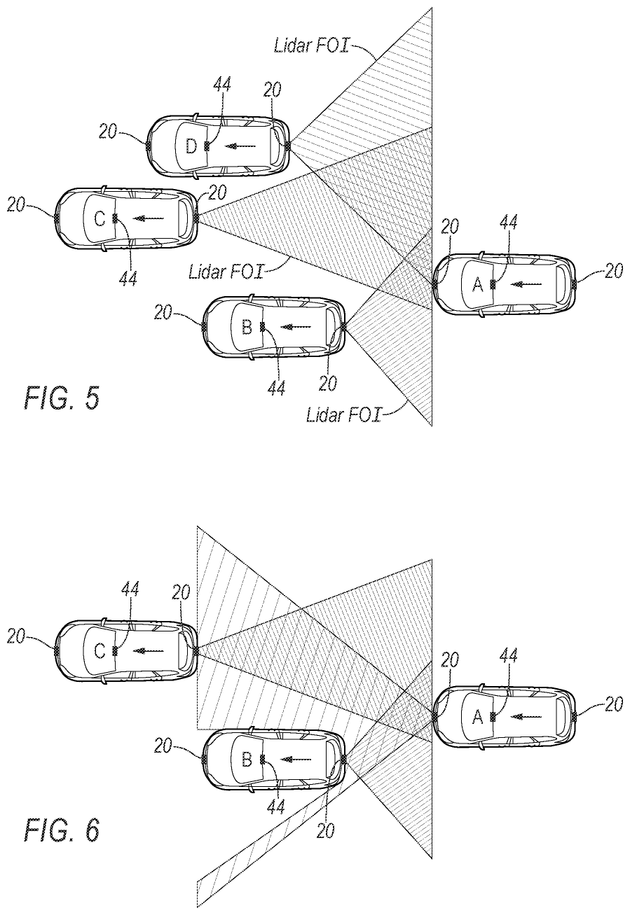

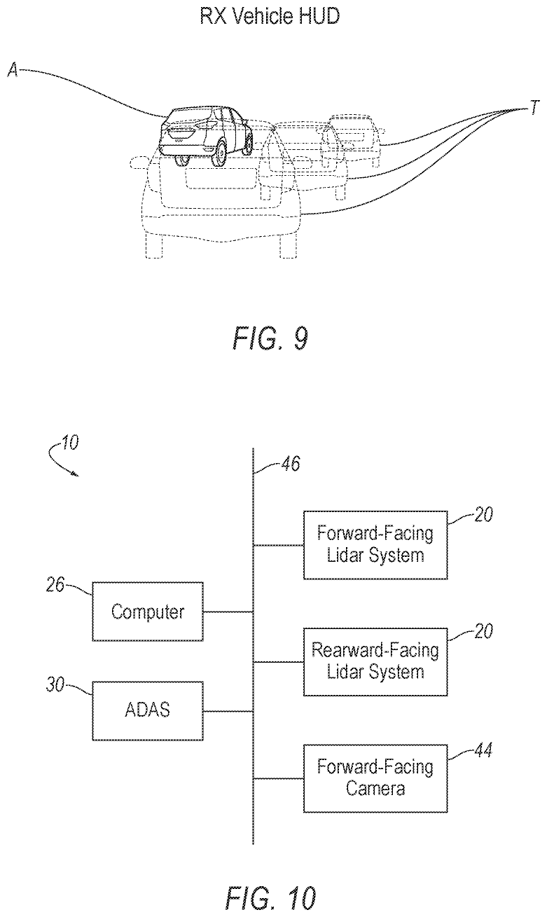

The lidar system 20 receives data both by illuminating a field of view (FOV) and detecting returned light reflected by objects in the field of view FOV (as is known of lidar systems) and by demodulating the modulated light that is received by the lidar system 20. The lidar system 20 may combine data from both of these sources to generate an environmental map. Specifically, the lidar system 20 may use the data from the demodulated light to augment the environmental map produced with returned light from the illuminated FOV. In such an example, the lidar system 20 is able to see through other vehicles. For example, in the examples shown in FIGS. 5-8, each of the vehicles 28 includes a lidar system 20 facing forward, a lidar system 20 facing rearward, and a camera 44 facing forward. A front vehicle may obtain image data detailing the scene in front of the vehicle, e.g., with video from the camera 44 and/or data from the forward-facing lidar system 20, and may transmit that image data to a rear vehicle by emitting modulated light from the light emitter 22 of the rearward-facing lidar system 20 of the front vehicle that is aimed in the direction of the rear vehicle. This modulated light is detected by the light detector 18 of the forward-facing lidar system 20 of the rear vehicle and is demodulated to extract the data. The forward-facing lidar system 20 of the rear vehicle also operates to illuminate the FOV in front of the rear vehicle to generate an environmental map based on the returned light. Since the front vehicle transmitted data detailing the scene in front of the front vehicle, the forward-facing lidar system 20 of the rear vehicle may use that data to essentially see through the front vehicle. An example of this is shown in FIG. 9, which shows a heads-up display in which a forward vehicles transmitting forward image data to a receiving vehicle, so that receiving vehicle knows what is in front of the forward vehicles, essentially making the forward vehicles appear in the scene but also able to be see-through. As described further below, the lidar system 20 of a vehicle 28 may receive modulated light from multiple vehicles, including receipt of modulated light simultaneously from multiple vehicles. In the example described above and the examples shown in the figures, the scene in front of vehicles is transmitted to a rear vehicle, but it should be appreciated that the lidar systems 20 may be positioned so the vehicle transmitting the modulated light and the vehicle receiving the modulated light may be in any relative position, e.g., the lidar systems 20 may be side-facing lidar systems.

In addition or in the alternative to image data being transmitted by modulated light, the lidar system 20 may receive modulated light carrying other types of data from other sources. As an example, the modulated light may be emitted from a light source that modulates code for software updates for various software of the vehicle, code that triggers a built-in-self test, code that triggers sensor diagnostics for various vehicle sensors. This data may be transmitted during operation of the vehicle on roadways, e.g., modulated light transmitted from other vehicles, road infrastructure, etc. As another example, this data may be transmitted during vehicle maintenance at a vehicle-maintenance facility. In any event, a single light source may provide the modulated light to multiple vehicles and may provide the modulated light simultaneously to multiple vehicles.

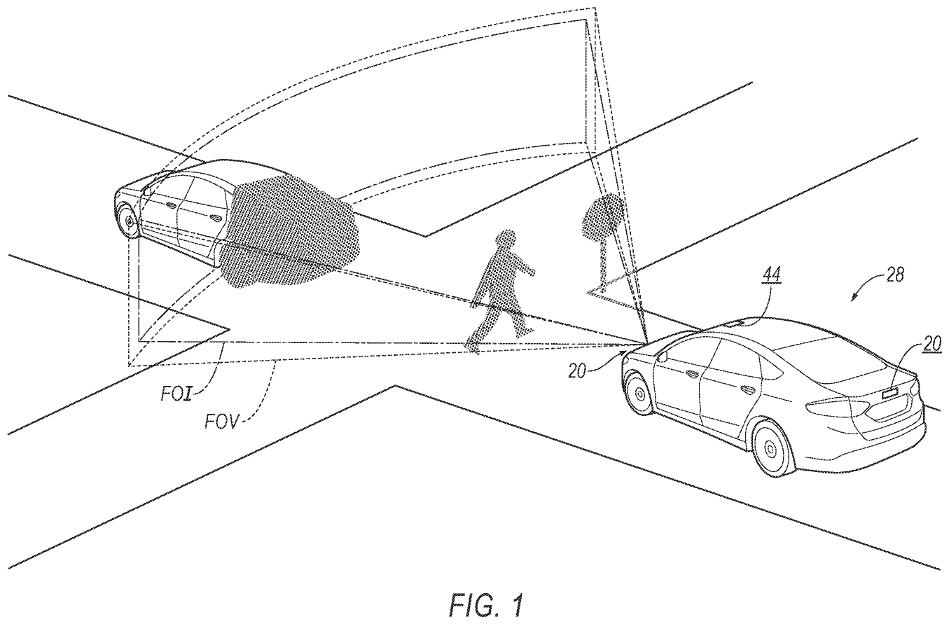

FIG. 1 shows an example vehicle 28. The lidar system 20 is mounted to the vehicle 28. In such an example, the lidar system 20 is operated to detect objects in the environment surrounding the vehicle 28 and to detect distances of those objects for environmental mapping, i.e., determine the range of the objects based on light detected by the lidar system 20. The output of the lidar system 20 may be used, for example, to autonomously or semi-autonomously control the operation of the vehicle 28, e.g., propulsion, braking, steering, etc. Specifically, the lidar system 20 may be a component of or in communication with an advanced driver-assistance system (ADAS) 30 of the vehicle 28. The lidar system 20 may be mounted on the vehicle 28 in any suitable position and aimed in any suitable direction. As one example, operation of one lidar system 20 on the front of the vehicle 28 and directed forward is shown in FIG. 1. The vehicle 28 may have more than one lidar system 20 and/or the vehicle 28 may include other object detection systems, such as a camera 44 as described below. For example, in FIGS. 5-8, each of the vehicles 28 includes a forward-facing lidar system 20, a rearward-facing lidar system 20, and another forward-facing object-detection system, e.g., a forward-facing camera 44. The lidar systems 20 and cameras 44 shown in FIGS. 5-8 are shown as examples and the vehicle 28 may include any suitable number of lidar systems 20 and other object-detection systems. The vehicle 28 shown in the Figures is a passenger automobile. As other examples, the vehicle 28 may be of any suitable manned or un-manned type including a plane, satellite, drone, watercraft, etc.

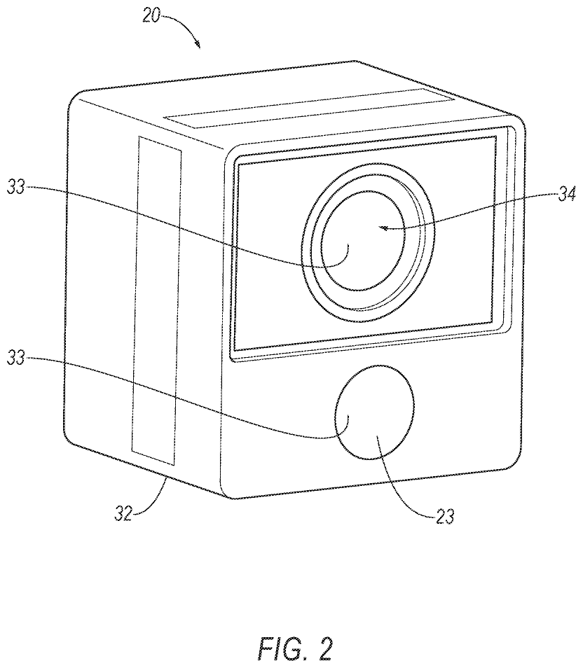

The multiple lidar systems 20 of the vehicle 28 are described with common numerals to identify common features. The lidar system 20 may be, as an example, a solid-state lidar system 20. In such an example, the lidar system 20 is stationary relative to the vehicle 28. For example, the lidar system 20 may include a casing 32 (shown in FIG. 2 and described below) that is fixed relative to the vehicle 28, i.e., does not move relative to the component of the vehicle 28 to which the casing 32 is attached, and a silicon substrate of the lidar system 20 is supported by the casing 32.

As a solid-state lidar system, the lidar system 20 may be a flash lidar system. In such an example, the lidar system 20 emits pulses of light into the field of illumination FOI (FIG. 1). More specifically, the lidar system 20 may be a 3D flash lidar system 20 that generates a 3D environmental map of the surrounding environment, as shown in part in FIG. 1. An example of a compilation of the data into a 3D environmental map is shown in the FOV and the field of illumination (FOI) in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 28, e.g., a point where a longitudinal axis and a lateral axis of the vehicle 28 intersect.

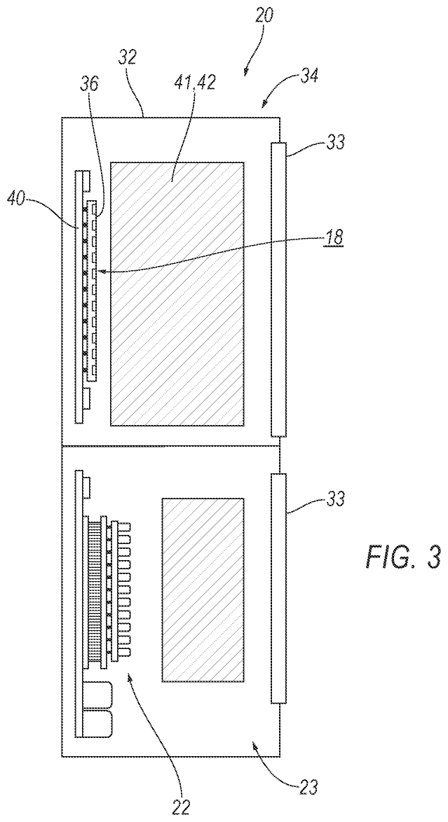

In such an example, the lidar system 20 is a unit. With reference to FIGS. 2 and 3, the lidar system 20 may include the casing 32, an outer optical window 33, a light receiving system 34, and a light emitting system 23. The light receiving system 34 includes a light detector 18, such as a focal-plane array (FPA) 36.

The casing 32, for example, may be plastic or metal and may protect the other components of the lidar system 20 from environmental precipitation, dust, etc. In the alternative to the lidar system 20 being a unit, components of the lidar system 20, e.g., the light emitting system 23 and the light receiving system 34, may be separate and disposed at different locations of the vehicle 28. The lidar system 20 may include mechanical attachment features to attach the casing 32 to the vehicle 28 and may include electronic connections to connect to and communicate with electronic system of the vehicle 28, e.g., components of the ADAS.

The outer optical window 33 allows light to pass through, e.g., light generated by the light emitting system 23 exits the lidar system 20 and/or light from environment enters the lidar system 20. The outer optical window 33 protects an interior of the lidar system 20 from environmental conditions such as dust, dirt, water, etc. The outer optical window 33 is typically formed of a transparent or semi-transparent material, e.g., glass, plastic. The outer optical window 33 may extend from the casing 32 and/or may be attached to the casing 32.

With reference to FIGS. 1-3, the lidar system 20 includes the light emitter 22 that emits shots, i.e., pulses, of light into the field of illumination FOI for detection by a light-receiving system 34 when the light is reflected by an object in the field of view FOV. The light-receiving system 34 has a field of view (hereinafter “FOV”) that overlaps the field of illumination FOI and receives light reflected by surfaces of objects, buildings, road, etc., in the FOV. The light emitter 22 may be in electrical communication with the computer 26, e.g., to provide the shots in response to commands from the computer 26.

With reference to FIG. 3, the light emitting system 23 may include one or more light emitter 22 and optical components such as a lens package 41, lens crystal 42, pump delivery optics, etc. The optical components, e.g., lens package 41, lens crystal 42, etc., may be between the light emitter 22 on a back end of the casing 32 and the outer optical window 33 on a front end of the casing 32. Thus, light emitted from the light emitter 22 passes through the optical components before exiting the casing 32 through the outer optical window 33.

The light emitter 22 may be a semiconductor light emitter, e.g., laser diodes. In one example, as shown in FIG. 3, the light emitter 22 may include a vertical-cavity surface-emitting laser (VCSEL) emitter. As another example, the light emitter 22 may include a diode-pumped solid-state laser (DPSSL) emitter. As another example, the light emitter 22 may include an edge emitting laser emitter. The light emitter 22 may be designed to emit a pulsed flash of light, e.g., a pulsed laser light. Specifically, the light emitter 22, e.g., the VCSEL or DPSSL or edge emitter, is designed to emit a pulsed laser light. Each pulsed flash of light may be referred to as the “shot” as used herein. The light emitted by the light emitter 22 may be infrared light. Alternatively, the light emitted by the light emitter 22 may be of any suitable wavelength. The lidar system 20 may include any suitable number of light emitters 22. In examples that include more than one light emitter 22, the light emitters 22 may be identical or different.

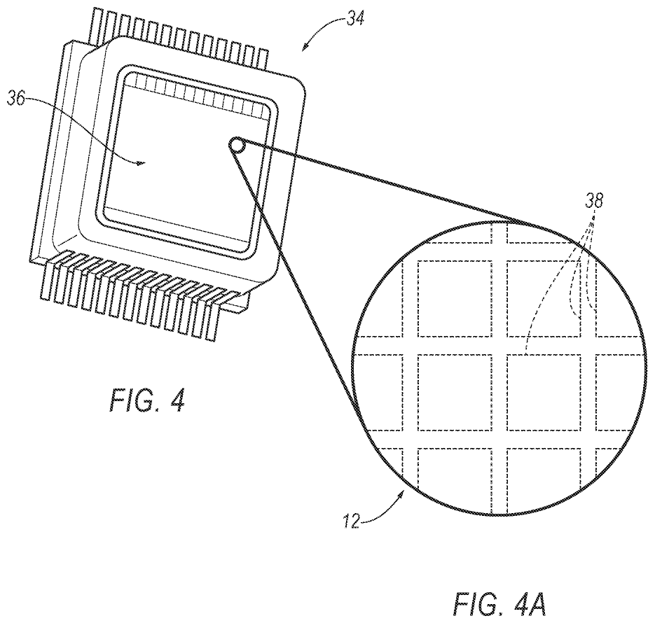

With reference to FIGS. 3 and 4, the light-receiving system 34 detects light, e.g., emitted by the light emitter 22. The light-receiving system 34 includes the light detector 18. An example of the light detector 18 is a focal-plane array (FPA) 36. The FPA 36 can include an array of pixels 38. Each pixel 38 can include at least one of photodetectors 24 and a read-out circuit (ROIC) 40. A power-supply circuit (not numbered) may power the pixels 38. The FPA 36 may include a single power-supply circuit in communication with all photodetectors 24 or may include a plurality of power-supply circuits in communication with a group of the photodetectors 24. The light-receiving system 34 may include receiving optics such as the lens package. The light-receiving system 34 may include an outer optical window and the receiving optics may be between the receiving outer optical window and the FPA 36. The pixel 38 reads to a histogram. The pixel 38 can include one photodetector 24 that reads to a histogram or a plurality of photodetectors 24 that each read to the same histogram. In the event the pixel 38 includes multiple photodetectors 24, the photodetectors 24 may share chip architecture.

The FPA 36 detects photons by photo-excitation of electric carriers, e.g., with the photodetectors 24. An output from the FPA 36 indicates a detection of light and may be proportional to the amount of detected light. The outputs of FPA 36 are collected to generate a 3D environmental map, e.g., 3D location coordinates of objects and surfaces within FOV of the lidar system 20. The FPA 36 may include the photodetectors 24, e.g., that include semiconductor components for detecting laser and/or infrared reflections from the FOV of the lidar system 20. The photodetectors 24, may be, e.g., photodiodes (i.e., a semiconductor device having a p-n junction or a p-i-n junction) including avalanche photodetectors, metal-semiconductor-metal photodetectors, phototransistors, photoconductive detectors, phototubes, photomultipliers, etc. Optical elements such as a lens package of the light-receiving system 34 may be positioned between the FPA 36 in the back end of the casing 32 and the outer optical window on the front end of the casing 32.

The ROIC 40 converts an electrical signal received from photodetectors 24 of the FPA 36 to digital signals. The ROIC 40 may include electrical components which can convert electrical voltage to digital data. The ROIC 40 may be connected to the computer 26, which receives the data from the ROIC 40 and may generate 3D environmental map based on the data received from the ROIC 40.

Each pixel 38 may include one photodetector 24 connected to the power-supply circuits. Each power-supply circuit may be connected to one of the ROICs 40. Said differently, each power-supply circuit may be dedicated to one of the pixels 38 and each read-out circuit 40 may be dedicated to one of the pixels 38. Each pixel 38 may include more than one photodetector 24.

The pixel 38 functions to output a single signal or stream of signals corresponding to a count of photons incident on the pixel 38 within one or more sampling periods. Each sampling period may be picoseconds, nanoseconds, microseconds, or milliseconds in duration. The pixel 38 can output a count of incident photons, a time between incident photons, a time of incident photons (e.g., relative to an illumination output time), or other relevant data, and the lidar system 20 can transform these data into distances from the system to external surfaces in the fields of view of these pixels 38. By merging these distances with the position of pixels 38 at which these data originated and relative positions of these pixels 38 at a time that these data were collected, the computer 26 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

The pixels 38 may be arranged as an array, e.g., a 2-dimensional (2D) or a 1-dimensional (1D) arrangement of components. A 2D array of pixels 38 includes a plurality of pixels 38 arranged in columns and rows.

The photodetector 24 may be of any suitable type. As one example, the photodetector 24 may be an avalanche-type photodetector. In other words, the photodetector 24 may be operable as an avalanche photodiode (APD) and/or a single-photon avalanche diode (SPAD) based on the bias voltage applied to the photodetector 24.

The power-supply circuit supplies power to the photodetector 24. The power-supply circuit may include active electrical components such as MOSFET (Metal-Oxide-Semiconductor Field-Effect Transistor), BiCMOS (Bipolar CMOS), etc., and passive components such as resistors, capacitors, etc. The power-supply control circuit may include electrical components such as a transistor, logical components, etc. The power-supply control circuit may control the power-supply circuit, e.g., in response to a command from the computer 26, to apply bias voltage (and quench and reset the photodetectors 24 in the event the photodetector 24 is operated as a SPAD).

Data output from the ROIC 40 may be stored in memory, e.g., for processing by the computer 26. The memory may be DRAM (Dynamic Random Access Memory), SRAM (Static Random Access Memory), and/or MRAM (Magneto-resistive Random Access Memory) electrically connected to the ROIC 40.

Light emitted by the light emitter 22 may be reflected off an object back to the lidar system 20 and detected by the photodetectors 24. An optical signal strength of the returning light may be, at least in part, proportional to a time of flight/distance between the lidar system 20 and the object reflecting the light. The optical signal strength may be, for example, an amount of photons that are reflected back to the lidar system 20 from one of the shots of pulsed light. The greater the distance to the object reflecting the light/the greater the flight time of the light, the lower the strength of the optical return signal, e.g., for shots of pulsed light emitted at a common intensity. As described above, the lidar system 20 generates a histogram for each pixel 38 based on detection of returned shots. The histogram may be used to generate the 3D environmental map including determining the range of objects in the field of view FOV of the lidar system 20 based on light detected by the photodetectors 24. As set forth above, the pixel 38 reads to a histogram. The pixel 38 can include one photodetector 24 that reads to a histogram or a plurality of photodetectors 24 that each read to the same histogram. In the event the pixel 38 includes multiple photodetectors 24, the photodetectors 24 may share chip architecture. Each bin of the histogram is associated with a time range of light detection. For each shot emitted from the light emitter 22 of the lidar system 20, a count is added at a bin associated with the time range at which light is detected by the pixel 38. A count is added to the bin for each occurrence of light detection and the histogram is cumulative for all of the shots.

As set forth above, the vehicle 28 may include one or more cameras 44. The camera 44 may include, for example, a CCD image sensor or a CMOS image sensor to generate data from light that is detected by the camera 44. The image generated by the camera 44 may be specified in the data as an array of pixels having different values of color, brightness, etc. The camera 44 may provide the data to the ADAS, e.g., via a communication network, such as a vehicle bus or the like. The camera 44 generates image data from detected light and specifying an image. The image data may be data depicting a still image. As another example of image data, the camera 44 and/or ADAS 30 may combine frames of images to generate a video.

As set forth above, the lidar system 20 receives data both by illuminating a field of view (FOV) and detecting returned light reflected by objects in the field of view (as described above) and by demodulating the modulated light that is received by the lidar system 20 (as described below). This modulated light may be emitted from another lidar system 20. The lidar system 20 may also emit modulated light carrying image data for detection by another lidar system 20.

In the examples shown in FIGS. 5-9, each of the vehicles 28 includes a forward-facing lidar system 20, a rearward-facing lidar system 20, and another forward-facing object-detection system. This other forward-facing object detection system is shown, for example, as a forward-facing camera 44 in FIGS. 5-9 and, as other examples, may be yet another lidar system 20 or any other type of object detection system that generates image data.

FIG. 5 shows several vehicles 28 traveling in a common direction with vehicle A behind vehicle B, vehicle C, and vehicle D. This example shows the rearward-facing lidar systems 20 of vehicle B, vehicle C, and vehicle D each emitting modulated light detected by the forward-facing lidar system 20 of vehicle A. The forward-facing lidar system 20 of vehicle A may simultaneously detect the modulated light from vehicle B, vehicle C, and/or vehicle D.

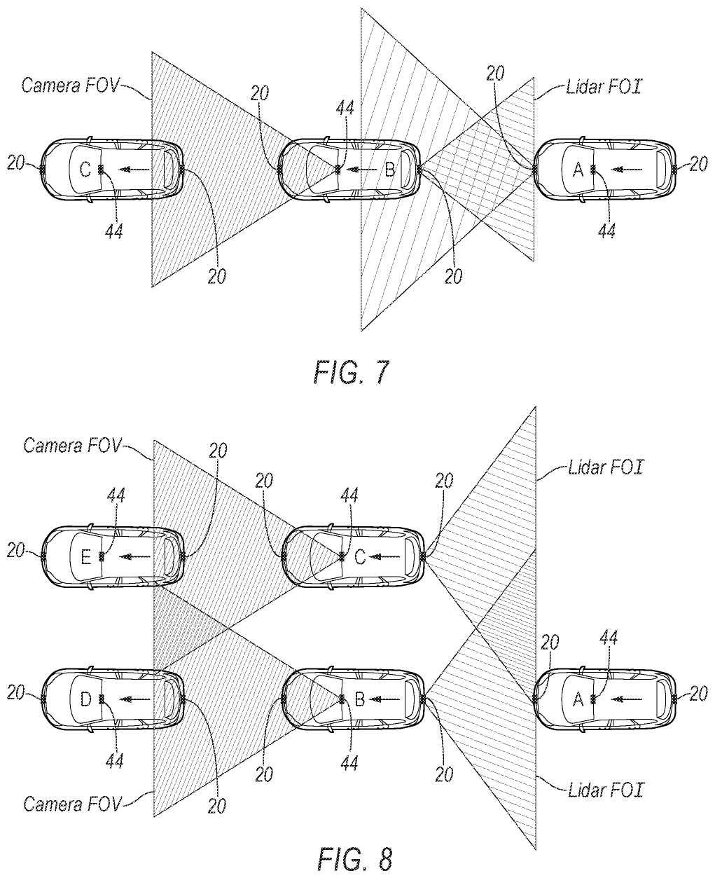

FIGS. 6 and 7 show the relative movement of three vehicles 28 labeled vehicle A, vehicle B, and vehicle C. In FIG. 6, the forward-facing lidar system 20 of vehicle A detects both vehicle B and vehicle C by illuminating the FOV and detecting returned light reflected by vehicle B and vehicle C. In FIG. 7, vehicle 28 has moved in front of vehicle B so that the forward-facing lidar system 20 of vehicle A detects vehicle B but vehicle B obstructs detection of vehicle C by the lidar system of vehicle A. Specifically, vehicle B blocks all light emitted by the lidar system of vehicle A from reaching vehicle C. The forward-facing camera 44 of vehicle B detects the image of vehicle C and the light emitter 22 of the rearward-facing lidar system 20 of vehicle B emits modulated light carrying image data from the forward-facing camera 44 of vehicle B. This modulated light is received by the forward-facing lidar system 20 of vehicle A, which extracts the image data from the modulated light. Vehicle A may use the combination of the detection of vehicle B by illuminating the FOV and detecting returned light reflected by vehicle B and the image data associated with vehicle C as detected by the forward-facing camera 44 of vehicle B to essentially see through vehicle B. An example of this is shown on a view of a heads-up display in FIG. 9, which shows three vehicles (identified with T) as transparent. For example, in FIG. 9, the image around the transparent vehicles T and the outline of the transparent vehicles T may be detection of returned light by the lidar system 20 of the vehicle having the heads-up display, i.e., the receiving vehicle. The images visible through the transparent vehicles T are provided by the forward-facing camera 44 of the vehicles T that appear transparent, which is transmitted to the forward-facing lidar system 20 of the vehicle 28 having the heads-up display by modulated light emitted by the rearward-facing lidar systems 20 of the vehicles T shown as transparent. With reference again to FIGS. 6 and 7, the lidar system 20 of vehicle A may separately or simultaneously receive returned light reflected by vehicle B and the image data associated with vehicle C.

FIG. 8 is an example in which multiple vehicles 28 are detected. In FIG. 8, the forward-facing lidar system 29 of vehicle A detects vehicle B and vehicle C by illuminating the FOV and detecting returned light reflected by vehicle B and vehicle C. The FOV of the lidar system 20 of vehicle A is not shown in FIG. 8 merely for illustrative purposes so as to clearly depict the lidar FOIs of vehicle B and vehicle C. Vehicle B obstructs detection of vehicle D and vehicle C obstructs detection of vehicle E by the forward-facing lidar sensor 20 of vehicle A. The forward-facing camera 44 of vehicle B detects the image of vehicle D and the forward-facing camera 44 of vehicle C detects the image of vehicle E. The light emitter 22 of the rearward-facing lidar system 20 of vehicle B emits modulated light carrying image data from the forward-facing camera 44 of vehicle B and the light emitter 22 of the rearward-facing lidar system 20 of vehicle C emits modulated light carrying image data from the forward-facing camera 44 of vehicle C. This modulated light is received by the forward-facing lidar system 20 of vehicle A, which extracts the image data from the modulated light. Vehicle A may use the combination of the detection of vehicle B and vehicle C by illuminating the FOV and detecting returned light reflected by vehicle B and vehicle B; the image data associated with vehicle D as detected by the forward-facing camera 44 of vehicle B; and the image data associated with vehicle E as detected by the forward-facing camera 44 of vehicle C to essentially see through vehicle B and vehicle C. The lidar system 20 of vehicle A may separately or simultaneously receive returned light reflected by vehicle B and vehicle C; the image data associated with vehicle D; and the image data associated with vehicle E.

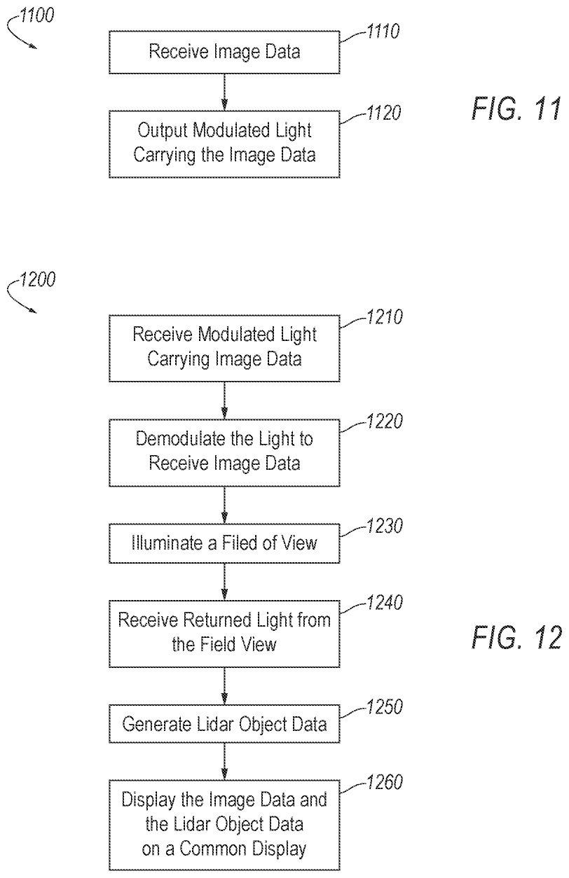

With reference to FIG. 10, the computer 26 is a microprocessor-based controller implemented via circuits, chips, or other electronic components. The computer 26 may be a component of the lidar system 20, i.e., each lidar system 20 may have a computer 26. As another example, the computer 26 may be a component of the vehicle 28, in which case multiple lidar systems 20 of the vehicle 28 may be in communication with the computer 26. The computer 26 is in electronic communication with the pixels 38 (e.g., with the ROIC 40 and power-supply circuits) and the vehicle 28 (e.g., with the ADAS 30) to receive data and transmit commands. The computer 26 includes a processor and a memory. The computer 26 of the vehicle 28 may be programmed to execute operations disclosed herein. Specifically, the memory stores instructions executable by the processor to execute the operations disclosed herein and electronically stores data and/or databases. electronically storing data and/or databases. The memory includes one or more forms of computer-readable media, and stores instructions executable by the computer 26 for performing various operations, including as disclosed herein, for example the methods 1100 and 1200 shown in FIGS. 11 and 12. The computer 26, for example, may include a dedicated electronic circuit including an ASIC (Application Specific Integrated Circuit) that is manufactured for a particular operation, e.g., calculating a histogram of data received from the lidar system 20 and/or generating a 3D environmental map for a Field of View (FOV) of the vehicle 28. In another example, the computer 26 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. The computer 26 may be a set of computers communicating with one another via the communication network of the vehicle 28, e.g., a computer in the lidar system 20 and a second computer in another location in the vehicle 28.

The computer 26 may be in communication with the ADAS 30 to operate the vehicle 28 in an autonomous, a semi-autonomous mode, or a non-autonomous (or manual) mode. For purposes of this disclosure, an autonomous mode is defined as one in which each of vehicle propulsion, braking, and steering are controlled by the ADAS 30; in a semi-autonomous mode the ADAS 30 controls one or two of vehicle propulsion, braking, and steering; in a non-autonomous mode a human operator controls each of vehicle propulsion, braking, and steering.

The ADAS 30 may be programmed to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., based on input from the computer 26, as well as to determine whether and when the ADAS 30, as opposed to a human operator, is to control such operations. Additionally, the computer 26 may be programmed to determine whether and when a human operator is to control such operations.

The computer 26 may include or be communicatively coupled to, e.g., via a vehicle communication bus, more than one processor, e.g., controllers or the like included in the vehicle for monitoring and/or controlling various vehicle controllers, e.g., a powertrain controller, a brake controller, a steering controller, etc. The computer 26 is generally arranged for communications on a vehicle communication network 46 that can include a bus in the vehicle such as a controller area network (CAN) or the like, and/or other wired and/or wireless mechanisms. The computer 26 may be in communication with the lidar systems 20 and the camera 44 through the communications network 46. As set forth above, the computer 26 may be a component of the lidar system 20 (e.g., each lidar system includes a computer 26) or may be a separate component from the lidar system 20.

As set forth above, the computer 26 demodulates light received by the light detector 18 to extract data from the modulated light. Specifically, the light waves of modulated light act as carrier signals to carry data. The amplitude, frequency, and/or phase of the light wave may be changed to transmit data as modulation to the light wave.

The data extracted from the modulated light received by the light detector 18 may be digital. In such an example, the computer 26 may use digital signal processing, e.g., using a digital-to-analog converter, to extract data from the modulated light, e.g., to extract image data.

Specifically, as set forth above, the data extracted from the modulated light received by the light detector 18 may include image data of a vehicle transmitted by a transmitting vehicle. An example of this include the transmission of image data of vehicle C from vehicle B to vehicle A in FIG. 6 as described above. Similar examples are in FIGS. 7 and 8.

As an example, such as is shown in FIGS. 6-8, the modulated light received by the light detector 18 may be emitted from a light emitter 22 of a lidar system 20 of another vehicle 28. As shown in FIG. 8, by way of example, the data extracted from modulated light received by the light detector 18 may include image data from multiple transmitting vehicles, e.g., image data of a vehicle (e.g., vehicle D) transmitted by the light emitter 22 of the lidar system 20 of a first transmitting vehicle (e.g., vehicle B) and image data of a vehicle (e.g., vehicle E) transmitted by the light emitter 22 of the lidar system 20 of a second transmitting vehicle (e.g., vehicle C). The image data transmitted by the first transmitting vehicle and the second transmitting vehicle may be for the same vehicle or different vehicles. As set forth above, the modulated light from the first transmitting vehicle and the modulated light from the second transmitting vehicle may be received separately and/or simultaneously by the light detector 18 of the receiving vehicle (e.g., vehicle A in FIG. 8).

The image data extracted from modulated light received by the light detector 18 may include video of a vehicle transmitted by a transmitting vehicle. For example, in the example of FIG. 6, vehicle B may transmit video of vehicle C by modulated light emitted from the light emitter 22 of the rearward-facing lidar sensor of vehicle B to the forward-facing lidar system 20 of vehicle A. The video of vehicle C may be captured by the forward-facing camera 44 of vehicle B. In such an example, image data for this video is transmitted by the modulated light. This image data may be digitized for transmission by the modulated light, e.g., with the use of an analog-to-digital converter.

As another example, the data extracted from the light received by the light detector 18 may include vehicle software updates. As set forth above, the software updates may be updates for various software of the vehicle, code that triggers a built-in-self test, code that triggers sensor diagnostics for various vehicle sensors. This data may be transmitted during operation of the vehicle on roadways, e.g., modulated light transmitted from other vehicles, road infrastructure, etc. As another example, this data may be transmitted during vehicle maintenance at a vehicle-maintenance facility. In any event, a single light source may provide the modulated light to multiple vehicles and may provide the modulated light simultaneously to multiple vehicles.

As set forth above, the lidar system 20 includes the light emitter 22 that is designed to emit pulses of light into the field of view FOV of the light detector 18 and the light detector 18 is designed to detect light reflected off an object in the field of view. Specifically, the light detector 18 may detect light reflected off a transmitting vehicle in the field of view and the transmitting vehicle may also transmit image data of a vehicle. For example, in FIG. 6, the light emitter 22 of the lidar system 20 of vehicle A emits pulses of light and the light detector 18 of the lidar system 20 of vehicle A detects light reflected off vehicle B. Vehicle B is a “transmitting vehicle” in that vehicle B transmits image data of vehicle C to vehicle A by emitting modulated light that is detected by the light detector 18 of the lidar system of vehicle A, as described above.

The lidar system 20 determines the range of the transmitting vehicle in the field of view based on light detected by the light detector 18. The system 10 combines the range of the transmitting vehicle, i.e., as detected by emitting light into the field of view and detecting reflected light, and the image data of a vehicle transmitted by the transmitting vehicle. For example, in the example shown in FIG. 6, the system 10 of vehicle A combines the range of vehicle B (as detected by light emitted by the light emitter 22 of the forward-facing lidar system 20 of vehicle A that is reflected by vehicle B and detected by the light detector 18 of the forward-facing lidar system 20 of vehicle A) with the image data of vehicle C transmitted with modulated light from the light emitter of the rearward-facing lidar system 20 of vehicle B to the forward-facing lidar system 20 of vehicle A.

The system 10 may combine the range of the transmitting vehicle and the image data transmitted by the transmitting vehicle in any suitable way. As one example, as shown in FIG. 9, the system 10 may display an image from the image data on a heads-up-display of a receiving vehicle (the “receiving vehicle” being the vehicle that receives modulated light from a transmitting vehicle that transmits the modulated light). FIG. 9 shows transparent vehicles on the heads-up display. For example, in FIG. 9, the image around the transparent vehicles and the outline of the transparent vehicles may be detection of returned light by the lidar system of the vehicle having the heads-up display. The image visible through the transparent vehicle is provided by the forward-facing camera of the transparent vehicle, which is transmitted to the forward-facing lidar system of the vehicle having the heads-up display by modulated light emitted by the rearward-facing lidar system of the transparent vehicle. The heads-up display may be in the passenger compartment of the vehicle and visible to drivers/occupants of the vehicle. For example, the heads-up display may be of the type known in the art.

In addition to receiving data both by detecting returned light reflected by objects in the field of view FOV and by demodulating the modulated light that is received by the lidar system 20, the lidar system 20 may also emit modulated light for receipt by other lidar systems 20 of other vehicles. Specifically, the computer 26 actuate the light emitter 22 to output modulated light carrying data for receipt by a second lidar system 20, i.e., on another vehicle 20. The light emitter 22 may modulate the light using any suitable modulation technique.

For example, the lidar system 20 may emit modulated light to transmit image data from another object detection sensor of the vehicle, e.g., the camera 44 in the examples described above and shown in the figures. As an example, in FIG. 7, the rear-facing lidar system 20 of vehicle B may receive image data from the forward-facing camera 44 of vehicle B. The computer 26 actuates the light emitter 22 of the rear-facing lidar system 20 to emit modulated light to transmit the image data from the forward-facing camera 44 of vehicle B to the forward-facing lidar system 20 of vehicle A. Vehicle A may then demodulate the light and use the image data as described above. As an example, the computer 26 actuates the light emitter 22 to modulate the light to transmit data associated with the video (e.g., video captured by the camera 44 of vehicle B in FIG. 7) for receipt by a second lidar system 20 (e.g., the forward-facing lidar system 20 of vehicle B in FIG. 7).

FIG. 11 is a process flow diagram illustrating an exemplary process 1100 for emitting modulated light with the lidar system 20. FIG. 12 is a process flow diagram illustrating an exemplary process 1200 for receiving modulated light with the lidar system 20.

With reference to FIG. 11, method 1100 includes receiving image data at block 1110. Specifically, the lidar system 20 to emit modulated light receives the image data. The lidar system 20 may receive image data in the form of instructions to modulate the light to transmit the data. For example, in the example shown in FIG. 7, the rear-facing lidar system 20 of vehicle B receives image data from the forward-facing camera 44 of vehicle B. Specifically, the image data received by the rear-facing lidar system 20 may be video.

The method 1100 includes outputting modulated light carrying the image data, as shown in block 1120. Specifically, the computer 26 instructs the light emitter 22 to emit modulated light carrying the image data. For example, in the example shown in FIG. 7, the light emitter 22 of the rear-facing lidar system 20 of vehicle B emits modulated light carrying the image data received from the forward-facing camera 44 of vehicle B in block 1100. This image data may be received by vehicle A.

In method 1200, the lidar system 20 both detects returned light reflected by objects in the field of view FOV and demodulates the modulated light that is received by the lidar system 20. This image data can be combined and displayed together.

With reference to FIG. 12, method 1200 includes receiving modulated light carrying image data, as shown in block 1210 and demodulating the modulated light. Accordingly, the computer 26 receives image data transmitted by the modulated light. The modulated light is received by the light detector 18 of the lidar system 20. As one example, in the example shown in FIG. 7, the forward-facing lidar system 20 of vehicle A may receive the modulated light emitted by vehicle B in block 1120 of FIG. 11. In other words, in such an example, the data is extracted from modulated light that is emitted from a light emitter 22 of another lidar system, e.g., a lidar system 20 a transmitting vehicle. As another example, the data extracted from the light received by the light detector 18 includes vehicle software updates. In such an example, the data may be transmitted from other vehicles, road infrastructure, a vehicle-maintenance facility, etc., as described above.

With reference to block 1220, the method 1200 includes demodulating the modulated light received by the light detector 18 to extract data from the light detected by the light detector 18. Specifically, the computer 26 demodulates the light. The demodulation may be performed by any suitable demodulation technique.

The data extracted from light received by the light detector 18 may include image data of a vehicle (e.g., vehicle C in FIG. 7) transmitted by a transmitting vehicle (e.g., vehicle B in FIG. 7). The data extracted from light received by the light detector 18 may include also include image data of a vehicle transmitted by a second transmitting vehicle (e.g., in FIG. 8, vehicle B being a first transmitting vehicle and vehicle C being a second transmitting vehicle). In such examples, the modulated light from multiple transmitting vehicles may be separately or simultaneously received by the lidar system 20 (e.g., the forward-facing lidar system 20 of vehicle A in FIG. 8).

With reference to block 1230 and 1240, the method 1200 includes actuating the light emitter 22 to emit pulses of light into the field of view of the light detector 18 and detecting light reflected from an object in the field of view with the light detector 18. The actuation of the light emitter 22 and the detection of light with the light detector 18 is described above.

With reference to block 1250, the method 1200 includes generating lidar object data. Specifically, the method 1200 includes determining the range objects in the field of view FOV based on light detected by the light detector 18. For example, the lidar system 20 may range a transmitting vehicle in the field of view based on light detected by the light detector 18. For example, in the example shown in FIG. 7, the transmitting vehicle, i.e., vehicle B which transmitted the modulated light, is ranged by the forward-facing lidar system 20 of vehicle A.

With reference to block 1260, the method includes combining the range of the transmitting vehicle and the image data of a vehicle transmitted by the transmitting vehicle. As one example, block 1260 may include displaying an image from the image data on a heads-up-display of a receiving vehicle, e.g., as shown in FIG. 9 and as described above.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a lidar system having a light emitter and a light detector; and
a computer having a processor and a memory storing instructions executable by the processor to:
demodulate modulated light received by the light detector to extract data from the modulated light.

2. The system as set forth in claim 1, wherein the data extracted from light received by the light detector includes image data of a vehicle transmitted by a transmitting vehicle.

3. The system as set forth in claim 2, wherein:
the light emitter is designed to emit pulses of light into the field of view of the light detector;
the light detector is designed to detect light reflected off a transmitting vehicle in the field of view; and
the memory stores instructions executable by the processor to:
determine the range of the transmitting vehicle in the field of view based on light detected by the light detector; and
combine the range of the transmitting vehicle and the image data of a vehicle transmitted by the transmitting vehicle.

4. The system as set forth in claim 3, wherein the memory stores instructions to display an image from the image data on a heads-up-display of a receiving vehicle.

5. The system as set forth in claim 2, wherein the data extracted from light received by the light detector includes image data of a vehicle transmitted by a second transmitting vehicle.

6. The system as set forth in claim 1, wherein the image data extracted from light received by the light detector includes video of a vehicle transmitted by a transmitting vehicle.

7. The system as set forth in claim 1, wherein the memory stores instructions executable by the processor to receive video and to actuate the light emitter to modulate the light to transmit data associated with the video for receipt by a second lidar system.

8. The system as set forth in claim 1, wherein the data extracted from the light received by the light detector includes vehicle software updates.

9. The system as set forth in claim 1, wherein the data extracted from the light received by the light detector is digital.

10. The system as set forth in claim 1, wherein the light received by the light detector is emitted from a light emitter of another lidar system.

11. The system as set forth in claim 1, wherein the memory stores instructions executable by the processor to actuate the light emitter to output modulated light carrying data for receipt by a second lidar system.

12. The system as set forth in claim 1, wherein:
the light emitter is designed to emit pulses of light into the field of view of the light detector;
the light detector is designed to detect light reflected from an object in the field of view; and
the memory stores instructions executable by the processor to determine the range of the object in the field of view based on light detected by the light detector.

13. The system as set forth in claim 1, further comprising a casing housing both the light emitter and the light detector.

14. A method comprising:
receiving modulated light with a light detector of a lidar system;
demodulate light received by the light detector to extract data from the light detected by the light detector.

15. The method as set forth in claim 14, wherein the data extracted from light received by the light detector includes image data of a vehicle transmitted by a transmitting vehicle.

16. The method as set forth in claim 15, further comprising:
actuating the light emitter to emit pulses of light into the field of view of the light detector;
detecting light reflected from an object in the field of view with the light detector;
determining the range of a transmitting vehicle in the field of view based on light detected by the light detector; and
combining the range of the transmitting vehicle and the image data of a vehicle transmitted by the transmitting vehicle.

17. The method as set forth in claim 16, further comprising displaying an image from the image data on a heads-up-display of a receiving vehicle.

18. The lidar system as set forth in claim 15, wherein the data extracted from light received by the light detector includes image data of a vehicle transmitted by a second transmitting vehicle.

19. The method as set forth in claim 14, wherein the data extracted from light received by the light detector includes video of a vehicle transmitted by a transmitting vehicle.

20. The method as set forth in claim 14, further comprising actuating the light emitter to output modulated light carrying data for receipt by a second lidar system.

21. The method as set forth in claim 14, further comprising receiving video and actuating the light emitter to modulate the light to transmit data associated with the video for receipt by a second lidar system.

22. The method as set forth in claim 14, wherein the data extracted from the light received by the light detector includes vehicle software updates.

23. The method as set forth in claim 14, wherein the data extracted from the light received by the light detector is digital.

24. The method as set forth in claim 14, wherein the light received by the light detector is emitted from a light emitter of another lidar system.

25. The method as set forth in claim 14, further comprising:
actuating the light emitter to emit pulses of light into the field of view of the light detector;
detecting light reflected from an object in the field of view with the light detector; and
determining the range of the object in the field of view based on light detected by the light detector.
